(19) United States
(12) Patent Application Publication
(10) Pub. No.: US 2018/0071851 A1
(43) Pub. Date: Mar. 15, 2018

(54) METHODS AND SYSTEMS FOR MULTI-VOLTAGE AND FREQUENCY ENGINE DRIVE

(71) Applicant: LINCOLN GLOBAL, INC., City of Industry, CA (US)

(72) Inventor: SAMIR FARAH, BROADVIEW HEIGHTS, OH (US)

(21) Appl. No.: 15/264,871

(22) Filed: Sep. 14, 2016

(51) Int. Cl. B23K 9/10; H02P 9/44

(52) U.S. Cl. CPC B23K 9/1006; H02P 9/44

(57) ABSTRACT

The invention described herein generally pertains to a system and method related to an engine-driven welding device that generate a welding voltage and an auxiliary voltage using a rotor/stator assembly at various frequency settings or revolutions per minute while maintaining outputs for the welding voltage and the auxiliary voltage. A welding device can include a field controller component and/or a controller that is configured to detect a change in a frequency setting or an engine speed. In response to such detection, the field controller component can be configured to adjust an excitation voltage in order to maintain a voltage output used for a welding voltage or an auxiliary power voltage power.

### TECHNICAL FIELD

In general, the present invention relates to a field controller component that adjusts an excitation voltage from a stator to feed into a rotor/stator assembly in to maintain an output voltage in response to a change in frequency or an engine speed.

### BACKGROUND OF THE INVENTION

Frequently, welding is required where supply power may not be readily available. As such, the welding power supply may be an engine driven welding power supply incorporating a generator. The generator may supply power to the welder as well as to other power tools as may be needed on site. As different applications require different versions of welders and power tools, the trailer may be designed to carry one of many different types of welding power supplies.

Depending on a country or region, a standardized voltage and frequency is used for electronic devices. For example, in United States, one of the standardize voltages of approximately 120 volts at 60 Hz can be used for most electronics whereas in Europe one of the standardized voltages is approximately 220 volts at 50 Hz. Typically, power sources are built with a specification having a particular voltage at a frequency. Such power sources are then isolated to be distributed, used, or sold in a region or country having that corresponding specification. Accordingly, an improved welding device, system, or methodology addressing these concerns is needed.

### SUMMARY OF THE INVENTION

In accordance with an embodiment of the present invention, a welding device is provided that includes an engine-driven welder assembly including an engine that is configured to rotate a shaft. The welding device can include a generator component having a rotor coupled to the shaft and a stator that houses the rotor, wherein the shaft rotates the rotor via the engine and a battery that provides an initial excitation of the rotor. The rotor and stator generate an auxiliary power voltage, a welding voltage, and an excitation voltage, each at a frequency dependent on a revolutions per minute of the rotor and each generated after the initial excitation of the rotor. The welding device further includes a field controller component that is configured to: adjust the excitation voltage based on the revolutions per minute and feed the adjusted excitation voltage to the rotor after the initial excitation to generate the auxiliary power voltage or the welding voltage. The welding device uses the welding voltage to perform a welding operation.

In accordance with an embodiment of the present invention, a method is provided that includes at least the steps of: exciting a rotor with an initial excitation voltage from a power source; generating an auxiliary power voltage at a target value, a welding voltage, and an excitation voltage with a rotational movement between the rotor and a stator; changing a frequency setting or an engine speed; adjusting the excitation voltage to account for the change in the frequency setting or the engine speed; and receiving the adjusted excited voltage at the rotor which induces the stator to generate the target auxiliary power voltage by at the frequency setting or with the engine speed.

In accordance with an embodiment of the present invention, a welder system is provided that includes at least the following: an engine-driven welder assembly including an engine that is configured to rotate a shaft; a generator component having a rotor coupled to the shaft and a stator that houses the rotor, wherein the shaft rotates the rotor via the engine; a battery that provides an initial excitation of the rotor; the stator generates an output based on a stator winding, an engine speed, and a rotation of the stator and rotor, wherein the output includes an auxiliary output, a welding output, or an excitation output; a controller that receives an instruction to change an engine speed or a frequency of the output, wherein the change in the engine speed or the frequency causes an increase or a decrease in the output; a field controller component that is configured to: receive the excitation output; adjust the excitation output; feed the adjusted excitation output to the rotor; and the stator generates the auxiliary output in response to the rotor receiving the adjusted excitation voltage and the change in the engine speed or the frequency.

These and other objects of this invention will be evident when viewed in light of the drawings, detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates a welding device;

FIG. 2 illustrates a welding device that is portable;

FIG. 3 illustrates a welding device affixed to a trailer for mobility;

FIG. 4 illustrates a welding device;

FIG. 5 illustrates a welding device without an exterior casing;

FIG. 6 is a block diagram illustrating a welding device;

FIG. 7 is a block diagram illustrating a system that adjusts an excitation voltage for a rotor/stator assembly.

FIG. 8 is a block diagram illustrating an embodiment of a field controller component used with a welding device; and

FIG. 9 is a flow diagram of a methodology of adjusting an excitation voltage to be delivered to a rotor to generate an output used for a welding operation or an auxiliary port.

### DETAILED DESCRIPTION OF THE INVENTION

Embodiments of the invention relate to methods and systems that relate to an engine-driven welding device that generate a welding voltage and an auxiliary voltage using a rotor/stator assembly at various frequency settings or revolutions per minute while maintaining target outputs for the welding voltage and the auxiliary voltage. A welding device can include a field controller component and/or a controller that is configured to detect a change in a frequency setting or an engine speed. In response to such detection, the field controller component can be configured to adjust an excitation voltage in order to maintain a voltage output used for a welding voltage or an auxiliary power voltage power. The adjustment to the excitation voltage can be an increased or a decrease dependent on the change of the frequency or the engine speed. Upon adjustment, the adjusted excitation voltage can be fed to the rotor/stator assembly to continue to generate the welding voltage and the auxiliary power voltage regardless of the change in the frequency or the engine speed.

The subject innovation can be used with any suitable engine-driven welder, engine-driven welding system, engine-driven welding apparatus, a welding system powered by an engine, a welding system powered by a battery, a welding system powered by an energy storage device, a hybrid welder (e.g., a welding device that includes an engine driven power source and an energy storage device or battery), or a combination thereof. It is to be appreciated that any suitable system, device, or apparatus that can perform a welding operation can be used with the subject innovation and such can be chosen with sound engineering judgment without departing from the intended scope of coverage of the embodiments of the subject invention. The engine driven welder can include a power source that can be used in a variety of applications where outlet power is not available or when outlet power will not be relied on as the sole source of power including portable power generation, backup power generation, heating, plasma cutting, welding, and gouging. The example discussed herein relates to welding operations, such as, arc welding, plasma cutting, and gouging operations. It is to be appreciated that a power source can generate a portion of power, wherein the portion of power is electrical power. It is to be appreciated that “power source” as used herein can be a motor, an engine, a generator, an energy storage device, a battery, a component that creates electrical power, a component that converts electrical power, or a combination thereof.

“Welding” or “weld” as used herein including any other formatives of these words will refer to depositing of molten material through the operation of an electric arc including but not limited to submerged arc, GTAW, GMAW, MAG, MIG, TIG welding, any high energy heat source (e.g., a laser, an electron beam, among others), or any electric arc used with a welding system. Moreover, the welding operation can be on a workpiece that includes a coating such as, but not limited to, a galvanized coating.

“Component” or “Controller” as used herein can be a portion of hardware, a portion of software, or a combination thereof that can include or utilize at least a processor and a portion of memory, wherein the memory includes an instruction to execute.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

With reference to the drawings, like reference numerals designate identical or corresponding parts throughout the several views. However, the inclusion of like elements in different views does not mean a given embodiment necessarily includes such elements or that all embodiments of the invention include such elements. The examples and figures are illustrative only and not meant to limit the invention, which is measured by the scope and spirit of the claims.

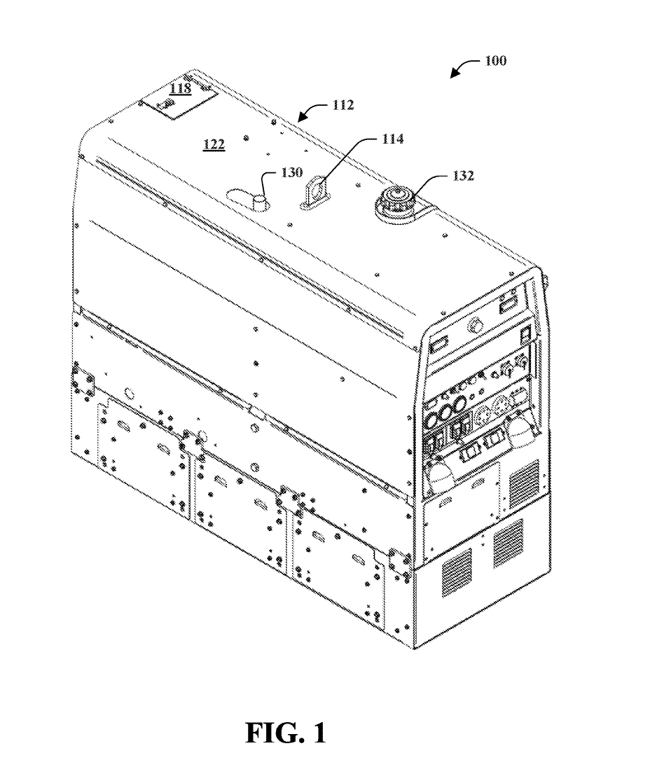

FIG. 1 illustrates a welding device 100. The welding device 100 includes a housing 112 which encloses the internal components of the welding device 100. Optionally, the welding type device 100 includes a loading eyehook 114 and/or fork recesses. The loading eyehook 114 and the fork recesses facilitate the portability of the welding device 100. Optionally, the welding-type device 100 could include a handle and/or wheels as a means of device mobility. The housing 112 can also include a plurality of access panels on a side of the welding device such as, but not limited to, top, bottom, front, back, left side and/or right side. Access panel 118 provides access to a top panel 122 of housing 112 while another access panel can provide access to a side of housing 112. In an embodiment, the welding device 100 can include an access panel is on one or both sides. These access panels can provide access to the internal components of the welding device 100 including, for example, a motor, a rotor/stator assembly, engine, components, circuits, wiring, an energy storage device suitable for providing welding-type power, among others. Moreover, one or more panels can include a louvered opening to allow for air flow through the housing 112.

The housing 112 of the welding-type device 100 also houses an internal combustion engine. The engine is evidenced by an exhaust port 130 and a fuel port 132 that protrude through the housing 112. The exhaust port 130 extends above the top panel 122 of the housing 112 and directs exhaust emissions away from the welding-type device 100. The fuel port 132 preferably does not extend beyond the top panel 122 or a side panel. Such a construction protects the fuel port 132 from damage during transportation and operation of the welding-type device 100. It is to be appreciated that the exhaust port 130 can be located on at least one of a top side (as depicted), bottom side, left side, right side, front side, or back side. Additionally, it is to be appreciated that the fuel port 132 can be located on at least one of a top side (as depicted), bottom side, left side, right side, front side, or back side.

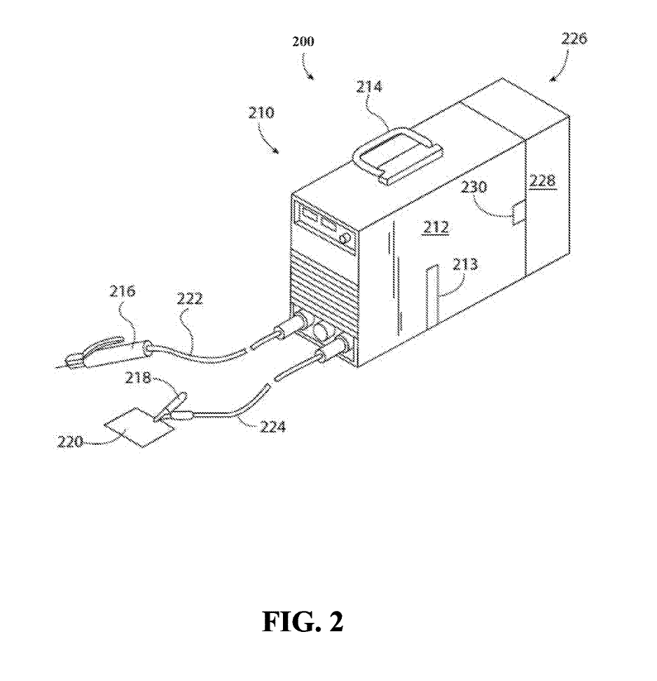

Referring now to FIG. 2, a perspective view of a welding apparatus 200 that can be utilized with the subject innovation. Welding apparatus 200 includes a power source 210 that includes a housing 212 enclosing the internal components of power source 210. As will be described in greater detail below, housing 212 encloses control components 213. Optionally, welding device 210 includes a handle 214 for transporting the welding system from one location to another. To effectuate the welding process, welding device 210 includes a torch 216 as well as a grounding clamp 218. Grounding clamp 218 is configured to ground a workpiece 220 to be welded. As is known, when torch 216 is in relative proximity to workpiece 220, a welding arc or cutting arc, depending upon the particular welding-type device, is produced. Connecting torch 216 and grounding clamp 218 to housing 212 is a pair of cables 222 and 224, respectively.

The welding arc or cutting arc is generated by the power source by conditioning raw power received from an interchangeable energy storage device 226. In a preferred embodiment, energy storage device 226 is a battery. Energy storage device 226 is interchangeable with similarly configured batteries. Specifically, energy storage device 226 is encased in a housing 228. Housing 228 is securable to the housing of welding device 210 thereby forming welding-type apparatus 200. Specifically, energy storage device 226 is secured to power source 210 by way of a fastening means 230. It is contemplated that fastening means 230 may include a clip, locking tab, or other means to allow energy storage device 226 to be repeatedly secured and released from power source 210.

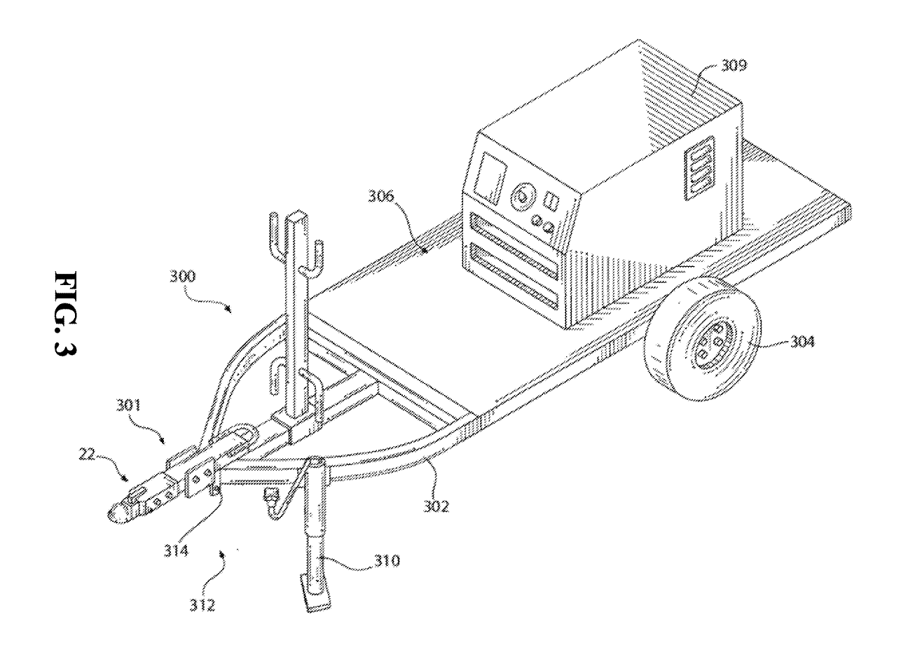

FIG. 3 illustrates a trailer 300 incorporating a trailer hitch or hitching device, depicted generally at 301. The trailer 300 may include a trailer frame 302 and one or more trailer wheels 304 in rotational connection with the trailer frame 302 and may further include a payload region 306 for carrying one or more cargo items, which in an exemplary manner may be a welding power supply 309 or an engine driven welding power supply 309. The trailer 300 may also include an adjustable stand 310 for adjusting the height of the front end 312 of the trailer 300. However, any means may be used for raising and/or lowering the front end 312 of the trailer 300. The trailer hitch 301 may be a generally longitudinal and substantially rigid trailer hitch 301 and may be attached to the frame 302 via fasteners 314, which may be threaded bolts.

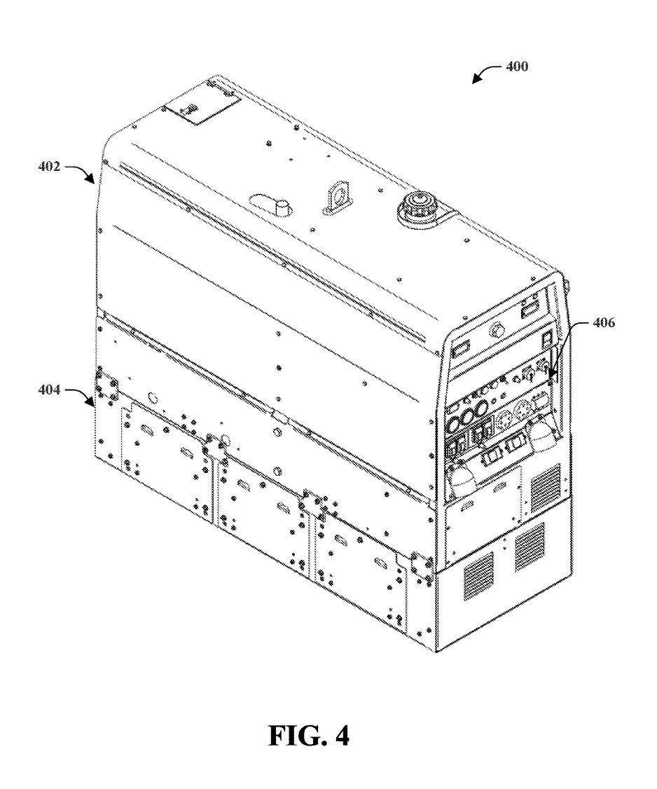

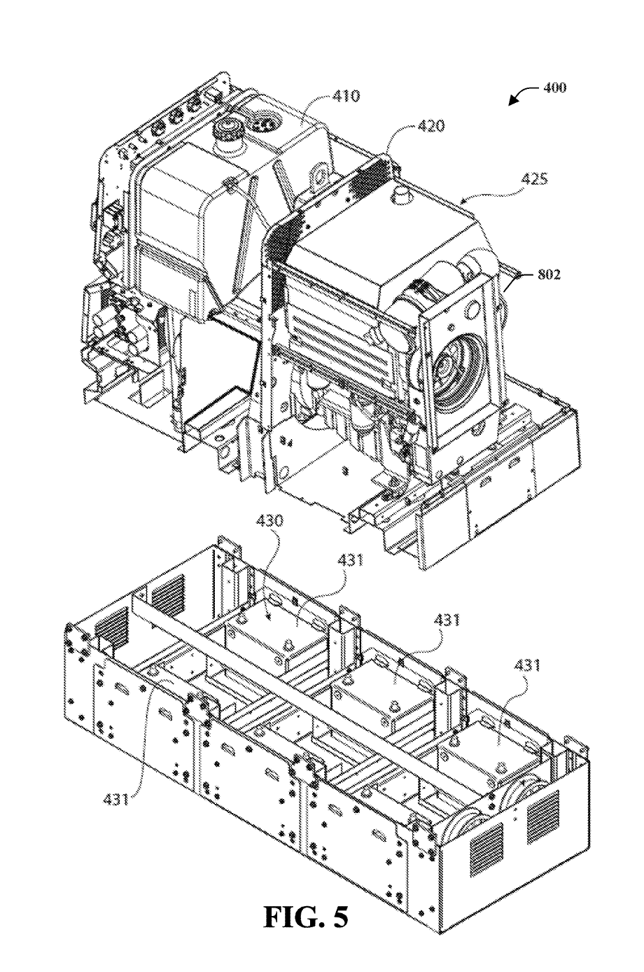

FIGS. 4 and 5 illustrate a hybrid welding device 400 (also referred to as a “hybrid welder”). A hybrid welder according to the invention is generally indicated by the number 400 in the drawings. Hybrid welder 400 is illustrated in FIG. 4 having the casing 112 and panels, whereas internals of hybrid welder 400 is illustrated in FIG. 5. Hybrid welder 400 in FIG. 4 can include an upper portion 402 and a lower portion 404, wherein the upper portion houses at least a portion of components associated with an engine component that utilizes a fuel to run and turn a shaft and the lower portion 404 can house at least one or more energy storage devices 430. The hybrid welder further includes a control panel 406 that can be located on a front face or side of the hybrid welder 400. The control panel 406 can allow settings to be configured via an input. By way of example and not limitation, the input can be buttons, keyboard, knobs, digital screen, touch screen, microphone for voice commands, connectors for welding components, switches, and the like.

Turning to FIG. 5, hybrid welder 400 includes an engine component that runs on fuel from fuel storage 410 allowing the hybrid welder 400 to be portable. It will be appreciated that hybrid welder 400 may also be mounted in a permanent location depending on the application, type of welding operation being performed, location of use for the welding, among others. Hybrid welder 400 generally includes a engine-driven welder assembly 420 having an engine 425 and an energy storage device 430. Engine 425 may be an internal combustion engine operating on any known fuel including but not limited to gasoline, diesel, ethanol, natural gas, hydrogen, and the like. These examples are not limiting as other motors or fuels may be used. It is to be appreciated that, in an example, the engine 425 can be a motor or electrical motor.

The engine 425 and energy storage device 430 may be operated individually or in tandem to provide electricity for the welding operation and any auxiliary operations performed by hybrid welder 400. For example, individual operation may include operating the engine 425 and supplementing the power from the engine 425 with power from the energy storage device 430 on an as needed basis or supplying power from the energy storage device 430 alone when the engine 425 is offline. Tandem operation may also include combining power from engine 425 and energy storage device 430 to obtain a desired power output. According to one aspect of the invention, a welder 400 may be provided with an engine having less power output than ordinarily needed, and energy storage device 430 used to supplement the power output to raise it to the desired power output level. In an embodiment, an engine with no more than 19 kW (25 hp) output may be selected and supplemented with six 12 volt batteries. Other combinations of engine output may be used and supplemented with more or less power from energy storage device. The above example, therefore, is not limiting.

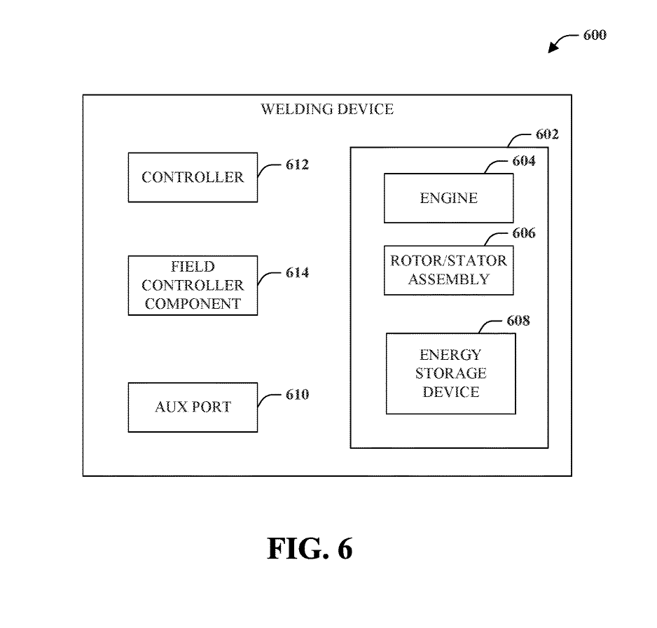

For instance, engine 425 can generate a voltage and such voltage can be stored in energy storage device 430. A controller 612 (illustrated in FIG. 6) can automatically select between engine 425 and energy storage device 430 for a power source for the welding operation performed by the hybrid welding device 400. In an embodiment, the controller 612 can select between engine 425 and energy storage device 430 based upon a welding parameter (discussed below). For instance, the controller can detect a particular welding parameter and based on such detection and/or value, a selection for the power source can be determined and employed. It is to be appreciated that the power source can be selected by the controller to be one of the following: solely the engine 425; solely the energy storage device 430; or a combination of the engine 425 and the energy storage device 430. For example, a combination of the engine 425 and the energy storage device 430 can be a ratio pre-defined or determined in-situ of the welding operation based on the detected welding parameter. In one embodiment, the welding parameter can be received by the controller and the controller can be programmed to set the power source to be 35% engine 425 and 65% energy storage device 430. It is to be appreciated that the power source can be a percentage of one of the engine 425 and/or the energy storage device 430.

Energy storage device 430 may be any alternative power source including a secondary generator, kinetic energy recovery system, or, as shown, one or more batteries 431. In an embodiment, six 12 volt batteries 431 are wired in series to provide power in connection with engine-driven welder assembly 420. Batteries 431 shown are lead acid batteries. Other types of batteries may be used including but not limited to NiCd, molten salt, NiZn, NiMH, Li-ion, gel, dry cell, absorbed glass mat, and the like.

FIG. 6 illustrates a block diagram of a welding device 600 that can be utilized by the subject innovation. The welding device 600 can be an embodiment of welding devices described in FIGS. 1-5. The welding device 600 can include a power source 602 that is configured to produce mechanical energy by combustion or by converting electrical energy. It is to be appreciated that alternative fuels or green energy can be used or employed by the power source 602 to produce energy. By way of example and not limitation, the power source 602 can be a motor, an engine, a solar panel, an energy storage device, a battery device, a rotor/stator assembly, a combination thereof, among others. It is to be appreciated that the power source 602 can deliver an initial excitation to a rotor/stator assembly 606 in order to start generate an output (e.g., voltage, current, etc.).

In an embodiment, the power source 602 can include an engine 604, the rotor/stator assembly 606, and/or an energy storage device 608. The engine 604 can be convert combustion energy into mechanical energy, wherein the engine 604 can be a heat combustion engine that burns a fuel. The rotor/stator assembly 606 can be configured to generate a portion of electrical current based on a rotation of a rotor housed within a stator. The energy storage device 608 can be used to store electrical energy that is used as an output for the power source 602. The power source 602 can be configured to produce a voltage, a current, and/or a power to be used with, for, or by the welding device 600. In particular, the welding device 600 can utilize an output of the power source 602 to perform a welding operation, to power a device external to the welding device 600 via an auxiliary port 610 (herein referred to as “aux port 610”), and/or to generate an excitation voltage to feedback into the power source 602.

Welding device 600 can be used to perform a welding operation based on the power source 602 having the rotor/stator assembly with a particular stator winding and such welding operation performed at a various frequency or engine speeds while maintaining the output of the power source 602. The rotor/stator assembly 606 can have a particular stator winding that corresponds to an output of the power source 602 at a first frequency and a first engine speed. The welding device 600 can be configured to allow adjustment of the first frequency and/or the first engine speed while maintaining the output of the power source 602 utilizing a field controller component 614. The field controller component 614 can adjust a portion of the output of the power source 602 in order to take into account of any changes from the change of the first frequency and/or the first engine speed to a second frequency and/or a second engine speed. Conventional power sources using a rotor/stator assembly will have a decrease in output if frequency or engine speed is lowered. Similarly, conventional power sources using a rotor/stator assembly will have an increase in output if frequency or engine speed is increased.

The power source 602 can include a stator winding for the rotor/stator assembly 606 that provides a target output when at a first frequency and/or a first engine speed. If a change to the first frequency and/or the first engine speed is employed, the target output for the power source 602 will not be achieved due to the change. The field controller component 614 can be configured to adjust an output from the power source 602 to compensate for a change in a frequency setting or an engine speed, wherein the adjustment is used to ensure the power source 602 provides the target output with the rotor/stator assembly 606. It is to be appreciated that the power source 602 can be a two pole design or a four pole design. Moreover, the power source 602 can include a design using any suitable number of poles. The subject innovation can be used with a rotor/stator assembly 606 that has a single stator winding configuration but it is to be appreciated that the subject innovation can be employed with a rotor/stator assembly 606 that includes multiple stator windings. For example, the field controller component 614 can adjust the output of the power source 602, having a target output for the specific stator winding and frequency or engine speed, to compensate for a change in frequency or engine speed for the stator winding setting in order to achieve the target output.

In a particular example, a power source can have a target output of 130 volts at 60 Hz using a four pole stator at 1800 RPM such that the target output of 130 volts can be used as voltage for a welding operation voltage (e.g., 5 volts), auxiliary power voltage (e.g., 120 volts), and an excitation voltage (e.g., 5 volts). Following this example, the engine speed or the frequency can be reduced which would cause a decrease in the target output. The field controller component 614 can be configured to adjust (here, an increase), an excitation voltage to be fed into the rotor/stator assembly 606 to produce the target output of 130 volts. If the field controller component 614 is not used, the target output of 130 volts would not be achieved.

Still following the above example, the engine speed or the frequency can be increased which would cause an increase in the target output. The field controller component 614 can be configured to adjust (here, a decrease), an excitation voltage to be fed into the rotor/stator assembly 606 to produce the target output of 130 volts. If the field controller component 614 is not used, the target output of 130 volts would not be achieved.

For example, a power source can have a target output of 230 volts at 50 Hz using a four pole stator at 1500 RPM such that the target output of 230 volts can be used as voltage for a welding operation voltage (e.g., 5 volts), auxiliary power voltage (e.g., 220 volts), and an excitation voltage (e.g., 5 volts). Following this example, the engine speed or the frequency can be reduced which would cause a decrease in the target output. The field controller component 614 can be configured to adjust (here, an increase), an excitation voltage to be fed into the rotor/stator assembly 606 to produce the target output of 230 volts. If the field controller component 614 is not used, the target output of 230 volts would not be achieved.

Still following the above example, the engine speed or the frequency can be increased which would cause an increase in the target output. The field controller component 614 can be configured to adjust (here, a decrease), an excitation voltage to be fed into the rotor/stator assembly 606 to produce the target output of 230 volts. If the field controller component 614 is not used, the target output of 230 volts would not be achieved.

Welding device 600 can further include a controller 612 that can be used to process one or more instructions using at least one processor and at least a memory in order to perform a welding operation, manage (e.g., distribute, regulate, etc.) power received from the power source 602, process instructions related to operation of the welding device 600, adjust settings from a control panel to adjust a welding parameter, among others. The controller 612 can control a wire feeder, the power source 602, field controller component 614, aux port 610, among others.

The controller 612 can be configured to process instructions related to at least changing a frequency of the welding device 600 or the power source 602, and/or changing an engine speed or revolutions per minute of the engine 604. An instruction can be received by the controller 612 based on a user input or a switch (e.g., internal and set by a manufacturer or external and accessible by a user). Upon detection of a change in the frequency or the engine speed (e.g., receipt of the instruction by the controller 612 for example), the field controller component 614 can be used to provide an adjustment to be used with the power source 602 in order to enable the power source 602 to generate a target output. For example, the change in frequency or engine speed can be based on a user input via a control panel. In another example, described below, the controller 612 can increase or decrease at least one of the frequency or the engine speed based on a welding parameter.

In still another example, described below, the controller 612 can decrease at least one of the frequency or the engine speed based on reducing fuel consumption for the engine. For example, a consumed fuel tank level or amount can be set to indicate that consumed fuel should be conserved. In order to conserve the consumed fuel, the controller 612 can reduce engine revolutions per minute (RPM) and/or frequency, wherein the field controller component 614 can employ adjustments to the output of the power source 602 to maintain a target output to be used for a welding operation or the aux port 610, among others.

It is to be appreciated that the output or target output of the power source 602 can be, but is not limited to, a voltage, a power, a current, a voltage used for welding (e.g., welding voltage), an auxiliary power voltage, an excitation voltage, among others. The auxiliary power voltage can be used for the aux port 610 to power or provide electricity to an external device. For example, the external device can connect via a cable or wireless receiver/transmitter located or associated with the aux port 610.

Additionally or alternatively, the controller 612 can adjust the frequency or the engine speed based on a welding parameter. By way of example, the welding parameter can be, a type of welding operation, a type of shielding gas, a material composition of workpiece W, a welding pattern, a type of electrode, a fuel tank level, an amount of charge in an energy storage device, a percentage of generating the output between the engine 604 and the energy storage device 608, a composition of electrode, a wire feed speed, a waveform used for the welding operation, a polarity of a welding wire, a type of flux, a number of electrodes used in the welding operation, an arc voltage, a travel speed of a tractor welder that performs the welding operation, a travel speed of a torch that performs the welding operation, an arc current level, a height of torch, a distance between workpiece W and torch or an end of the electrode, an oscillation width of electrode, a temperature of welding wire, a temperature of electrode, a type of material of workpiece W, a frequency of oscillation of electrode, a polarity of the arc current, a polarity of the current for welding wire, a parameter that affects an arc current of the welding operation, a gauge of wire, a material of wire, an oscillation dwell, a left oscillation dwell, a right oscillation dwell, one or more temperatures of workpiece W at one or more locations on workpiece W, a temperature of workpiece W, any and all variation of advanced process controls (e.g., move controls, pulse-frequency, ramp rates, background level ratios, etc.), and the like.

It is to be appreciated that welding device 600 can include one or more circuits, circuitry, or field controller components. As discussed above, there can be a field controller component for each stator winding used by the welding device 600. Additionally, the output can be configured based on the use of such output. For example, the power source 602 can produce an output that is partitioned and used for various functions such as, but not limited to, welding operation, auxiliary power, and/or excitation for the rotor/stator assembly 606. It is to be appreciated that a circuit or circuitry can be used upon receipt of a partitioned portion of the output in order to adapt for the particular functionality. By way of example and not limitation, a welding circuitry can be used and an auxiliary power circuitry can be used to adjust each respective portion of output received from the power source 602. In particular, the welding circuitry can adjust the portion of output received to be used for the welding operation. The auxiliary power circuitry can be used to adjust the portion of output received to be used for the aux port 610 and/or powering a device via the aux port 610.

It is to be appreciated that the field controller component 614 can be a stand-alone component within welding device 600 (as depicted), incorporated into the controller 612, incorporated into circuitry or components related to adjusting the output from the power source 602 (e.g., welding circuitry, auxiliary power circuitry, etc.), incorporated into the power source 602, or a combination thereof.

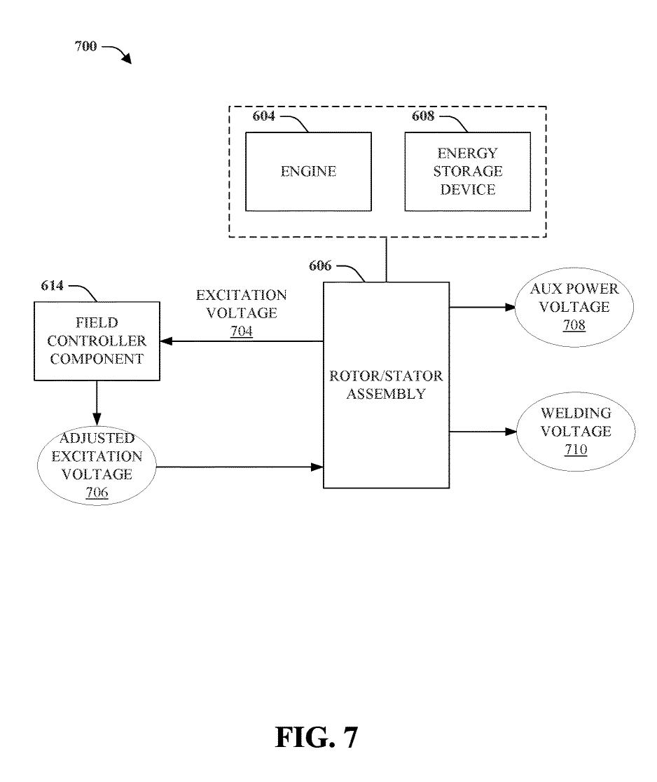

FIG. 7 illustrates a welding system 700 that allows frequency or engine speed to be changed while maintaining an output from the rotor/stator assembly 606. The welding system 700 can include the engine and the energy storage device 608 that can be configured to provide rotational movement to the rotor/stator assembly 606. By way of example and not limitation, the engine 604 can convert combustion energy into mechanical energy by burning a fuel. In another example, the energy storage device 608 can provide electrical energy to provide rotational movement to the rotor/stator assembly 606. It is to be appreciated that the engine 604 can provide rotational movement, the energy storage device 608 can provide rotational movement, or the engine 604 and the energy storage device 608 can provide rotational movement for the rotor/stator assembly 606.

In response to the rotational movement, the rotor/stator assembly 606 can generate an output. The output can include a target voltage that is utilized for at least one of excitation voltage 704, aux power voltage 708, and welding voltage 710. Based on a first engine speed and a stator winding of the rotor/stator assembly 606, the output will be a first frequency. If a change of the first engine speed or the first frequency is detected or requested, the output and the target voltage will change. In particular, if the first engine speed or the first frequency is increased, the output will be higher than the target voltage desired based on the configuration of the rotor/stator assembly 606 having more rotational movement. Similarly, if the first engine speed or the first frequency is decreased, the output will be lower than the target voltage desired based on the configuration of the rotor/stator assembly 606 having less rotational movement. The welding system 700 can be used to compensate for a change in the first frequency, wherein the frequency can be in the range of approximately 40 Hz to 100 Hz. Moreover, the welding system 700 can be used to compensate for a change in the first engine speed, wherein the engine speed can be in the range of approximately 1200 to 2000 revolutions per minute for a four pole power source and/or 2400 to 4000 revolutions per minute for a two pole power source.

In order to account for the change in the first engine speed or the first frequency, the field controller component 614 can adjust the excitation voltage 704 to account for such change. The field controller component 614 can include, but is not limited to including, a rheostat or a relay. In particular, the field controller component 614 can adjust the excitation voltage 704 with an increase or a decrease to produce an adjusted excitation voltage 706. The adjusted excitation voltage 706 can be fed or delivered to the rotor/stator assembly 606, wherein the adjusted excitation voltage 706 accounts for any loss or any overage in comparison to the target output and, in turn, the aux power voltage 708 and/or the welding voltage 710. In particular, the adjusted excitation voltage 706 can be delivered or fed into a stator of the rotor/stator assembly 606 to allow the rotor to generate the target value or output. In another example, the adjusted excitation voltage 706 can be delivered or fed into a rotor of the rotor/stator assembly 606 to allow the stator to generate the target value or output.

For example, the first frequency can be 60 Hz with a stator winding that provides a target output for the aux power voltage 708 to be 120 volts. It is to be appreciated that the aux power voltage 708 can be approximately in the range of 100 volts to 130 volts at a 60 Hz frequency. By way of example and not limitation, the aux power voltage 708 at 60 Hz frequency can be, but is not limited to, 100 volts, 110 volts, 115 volts, 120 volts, 127 volts, 220 volts, 230 volts, 240 volts among others. For example, the first frequency can be 60 Hz with a stator winding that provides a target output for the aux power voltage 708 to be 230 volts. It is to be appreciated that the aux power voltage 708 can be approximately in the range of 200 to 250 volts at a 60 Hz frequency. By way of example and not limitation, the aux power voltage 708 at 60 Hz frequency can be, but is not limited to, 100 volts, 110 volts, 115 volts, 120 volts, 127 volts, 220 volts, 230 volts, 240 volts, a voltage in the range of 100 to 250, among others.

Following this example, a change of the first engine speed or the first frequency, here 60 Hz, can result in the field controller component 614 producing an adjusted excitation voltage 706 to account for such change and allow the rotor/stator assembly 606 to produce the target output. If the change is a decrease in the first engine speed or the first frequency, the field controller component 614 can provide an adjustment of increasing the excitation voltage 704 to produce the adjusted excitation voltage 706 to feed into the rotor/stator assembly 606. If the change is an increase in the first engine speed or the first frequency, the field controller component 614 can provide an adjustment of decreasing the excitation voltage 704 to produce the adjusted excitation voltage 706 to feed into the rotor/assembly 606. In either change of the first frequency or the first engine speed, the adjusted excitation voltage 706 accounts for the change to enable the rotor/stator assembly 606 to output the target output for at least one of the aux power voltage 708 or the welding voltage 710.

In another example, the first frequency can be 50 Hz with a stator winding that provides a target output for the aux power voltage 708 to be 220 volts. It is to be appreciated that the aux power voltage 708 can be approximately in the range of 200 volts to 250 volts at a 50 Hz frequency. By way of example and not limitation, the aux power voltage 708 at 50 Hz frequency can be, but is not limited to, 100 volts, 220 volts, 230 volts, 240 volts, 100 volts, 110 volts, 115 volts, 120 volts, 127 volts, among others.

In another example, the first frequency can be 50 Hz with a stator winding that provides a target output for the aux power voltage 708 to be 110 volts. It is to be appreciated that the aux power voltage 708 can be approximately in the range of 100 volts to 130 volts at a 50 Hz frequency. By way of example and not limitation, the aux power voltage 708 at 50 Hz frequency can be, but is not limited to, 100 volts, 220 volts, 230 volts, 240 volts, 100 volts, 110 volts, 115 volts, 120 volts, 127 volts, a voltage in the range of 100 to 250, among others.

Following this example, a change of the first engine speed or the first frequency, here 50 Hz, can result in the field controller component 614 producing an adjusted excitation voltage 706 to account for such change and allow the rotor/stator assembly 606 to produce the target output. If the change is a decrease in the first engine speed or the first frequency, the field controller component 614 can provide an adjustment of increasing the excitation voltage 704 to produce the adjusted excitation voltage 706 to feed into the rotor/stator assembly 606. If the change is an increase in the first engine speed or the first frequency, the field controller component 614 can provide an adjustment of decreasing the excitation voltage 704 to produce the adjusted excitation voltage 706 to feed into the rotor/assembly 606. In either change of the first frequency or the first engine speed, the adjusted excitation voltage 706 accounts for the change to enable the rotor/stator assembly 606 to output the target output for at least one of the aux power voltage 708 or the welding voltage 710.

It is to be appreciated that the above description uses “voltage” and that such description includes the corresponding terms “current” or “power” based on the respective equations V=FR, where V is voltage, I is current, and R is resistance and P=V*I, where P is power, V is voltage, and I is current. Moreover, the voltages described above can be averages based on fluctuation.

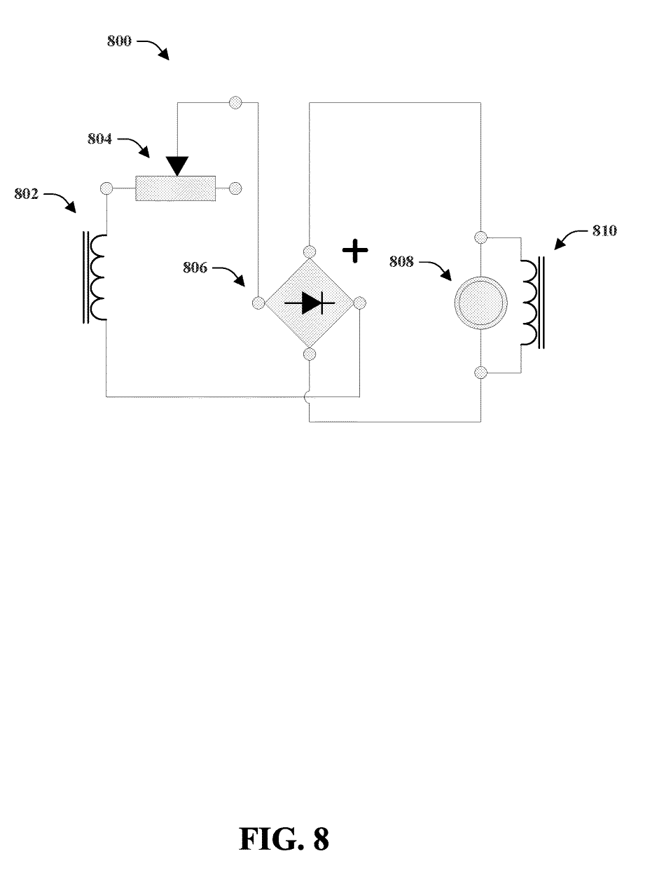

FIG. 8 illustrates a portion of circuitry 800 that can be used by the field controller component 614 to provide an increase or decrease adjustment to the excitation voltage of the rotor/stator assembly 606 running at 60 Hz and being changed to a lower or higher frequency or engine speed. The portion of circuitry 800 can receive an excitation voltage from a stator indicated at 802. A rheostat 804 can be configured to either increase or decrease the excitation voltage from the stator. A rectifier 806 converts the alternating current to a direct current for input to a rotor brushes 808 and a rotor 810. In another embodiment, the rheostat 804 can be replaced with a relay to provide an increased adjustment to the excitation voltage.

It is to be appreciated that the circuitry 800 that can be used by field controller component 614 and can be used to generate the adjustment excitation voltage 706 to provide an increase or decrease to the output of the rotor/stator assembly 606 to account for a decrease or increase in engine speed or a decrease in the frequency. In an embodiment, the circuitry 800 can be configured to provide an increase for the adjustment to the excitement voltage. In another embodiment, the circuitry 800 can be configured to provide an decrease for the adjustment to the excitement voltage. In still another embodiment, the circuitry 800 can be configured to provide an increase and/or a decrease for the adjustment to the excitement voltage.

In an embodiment, the stator further comprising a stator winding that corresponds to a total voltage output that is the summation of the auxiliary power voltage, the welding voltage, and the excitation voltage that are generated. In an embodiment, a controller is provided that receives an instruction to reduce the frequency dependent on the revolutions per minute of the rotor. In an embodiment, the frequency is 60 Hz and the adjustment is an increase in the excitation voltage to maintain the auxiliary power voltage. In an embodiment, the auxiliary voltage is approximately 120 volts. In an embodiment, a controller is provided that receives an instruction to increase the frequency dependent on the revolutions per minute of the rotor. In an embodiment, the frequency is 50 Hz and the adjustment is a decrease in the excitation voltage to maintain the auxiliary power voltage. In an embodiment, the auxiliary voltage is approximately 220 volts. In an embodiment, a switch component is provided that is configured to receive a change in the frequency or a change in the revolutions per minute of the engine. In an embodiment, the generator component further comprises two poles which provides the frequency of approximately 60 Hz at the revolutions per minute of approximately 3600. In an embodiment, the generator component further comprises four poles which provides the frequency of approximately 60 Hz at the revolutions per minute of approximately 1800. In an embodiment, the generator component further comprises four poles which provides the frequency of approximately 50 Hz at the revolutions per minute of approximately 1500. In an embodiment, the generator component further comprising two poles which provides the frequency of approximately 50 Hz at the revolutions per minute of approximately 3000. In an embodiment, the field controller component includes a rheostat and a rectifier. In an embodiment, the field controller component includes a rheostat. In the embodiment, the rheostat is configured to provide an increase or a decrease in voltage to the excitation output as the adjusted excitation output. In the embodiment, the field controller component includes a rectifier. In the embodiment, the field controller component includes a relay to provide an increase in voltage to the excitation output as the adjusted excitation output.

The aforementioned systems, components, (e.g., field controller component 614, controller 612, power source 602, rotor/stator assembly 606, energy storage device 608, welding device 600, among others), and the like have been described with respect to interaction between several components and/or elements. It should be appreciated that such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein.

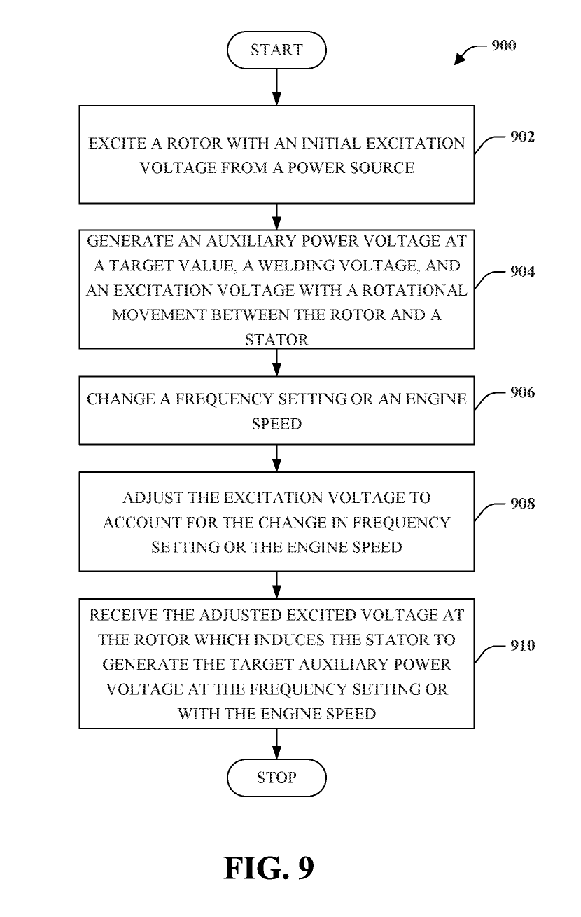

In view of the exemplary devices and elements described supra, methodologies that may be implemented in accordance with the disclosed subject matter will be better appreciated with reference to the flow charts of FIG. 9. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

FIG. 9 illustrates a methodology that can be implemented with one or more welding devices discussed in FIGS. 1-7, a field controller component as discussed in FIG. 8, or a welding device or system that uses a field controller component as described.

Sequentially, the following occurs as illustrated in the decision tree flow diagram 900 of FIG. 9 which is a flow diagram 900 that adjusts an excitation voltage to be delivered to a rotor/stator assembly to generate an output used for a welding operation or an auxiliary port. At reference block 902, a rotor is excited with an initial excitation voltage from a power source. At reference block 904, an auxiliary power voltage is generated at a target value, a welding voltage, and an excitation voltage with a rotational movement between the rotor and a stator. At reference block 906, a frequency setting or an engine speed is changed. At reference block 908, the excitation voltage is adjusted to account for the change in the frequency setting or the engine speed. At reference block 910, the adjusted excited voltage is received at the rotor which induces the stator to generate the target auxiliary power voltage at the frequency setting or with the engine speed.

While the embodiments discussed herein have been related to the systems and methods discussed above, these embodiments are intended to be exemplary and are not intended to limit the applicability of these embodiments to only those discussions set forth herein. The control systems and methodologies discussed herein are equally applicable to, and can be utilized in, systems and methods related to arc welding, laser welding, brazing, soldering, plasma cutting, waterjet cutting, laser cutting, and any other systems or methods using similar control methodology, without departing from the spirit or scope of the above discussed inventions. The embodiments and discussions herein can be readily incorporated into any of these systems and methodologies by those of skill in the art. By way of example and not limitation, a power supply as used herein (e.g., welding power supply, among others) can be a power supply for a device that performs welding, arc welding, laser welding, brazing, soldering, plasma cutting, waterjet cutting, laser cutting, among others. Thus, one of sound engineering and judgment can choose power supplies other than a welding power supply departing from the intended scope of coverage of the embodiments of the subject invention.

The above examples are merely illustrative of several possible embodiments of various aspects of the present invention, wherein equivalent alterations and/or modifications will occur to others skilled in the art upon reading and understanding this specification and the annexed drawings. In particular regard to the various functions performed by the above described components (assemblies, devices, systems, circuits, and the like), the terms (including a reference to a “means”) used to describe such components are intended to correspond, unless otherwise indicated, to any component, such as hardware, software, or combinations thereof, which performs the specified function of the described component (e.g., that is functionally equivalent), even though not structurally equivalent to the disclosed structure which performs the function in the illustrated implementations of the invention. In addition although a particular feature of the invention may have been disclosed with respect to only one of several implementations, such feature may be combined with one or more other features of the other implementations as may be desired and advantageous for any given or particular application. Also, to the extent that the terms “including”, “includes”, “having”, “has”, “with”, or variants thereof are used in the detailed description and/or in the claims, such terms are intended to be inclusive in a manner similar to the term “comprising.”

This written description uses examples to disclose the invention, including the best mode, and also to enable one of ordinary skill in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that are not different from the literal language of the claims, or if they include equivalent structural elements with insubstantial differences from the literal language of the claims.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

The best mode for carrying out the invention has been described for purposes of illustrating the best mode known to the applicant at the time and enable one of ordinary skill in the art to practice the invention, including making and using devices or systems and performing incorporated methods. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof. The patentable scope of the invention is defined by the claims, and may include other examples that occur to one of ordinary skill in the art. Such other examples are intended to be within the scope of the claims if they have structural elements that do not differentiate from the literal language of the claims, or if they include equivalent structural elements with insubstantial differences from the literal language of the claims.

What is claimed is:

1. A welding device, comprising:
an engine-driven welder assembly including an engine that is configured to rotate a shaft;
a generator component having a rotor coupled to the shaft and a stator that houses the rotor, wherein the shaft rotates the rotor via the engine;
a battery that provides an initial excitation of the rotor;
the rotor and stator generate an auxiliary power voltage, a welding voltage, and an excitation voltage, each at a frequency dependent on a revolutions per minute of the rotor and each generated after the initial excitation of the rotor;
a field controller component that is configured to:
adjust the excitation voltage based on the revolutions per minute;
feed the adjusted excitation voltage to the rotor after the initial excitation to generate the auxiliary power voltage or the welding voltage; and
the welding voltage is used by the welding device to perform a welding operation.

2. The welding device of claim 1, the stator further comprising a stator winding that corresponds to a total voltage output that is the summation of the auxiliary power voltage, the welding voltage, and the excitation voltage that are generated.

3. The welding device of claim 2, further comprising a controller that receives an instruction to reduce the frequency dependent on the revolutions per minute of the rotor.

4. The welding device of claim 3, wherein the frequency is 60 Hz and the adjustment is an increase in the excitation voltage to maintain the auxiliary power voltage.

5. The welding device of claim 4, wherein the auxiliary voltage is approximately 120 volts.

6. The welding device of claim 2, further comprising a controller that receives an instruction to increase the frequency dependent on the revolutions per minute of the rotor.

7. The welding device of claim 6, wherein the frequency is 50 Hz and the adjustment is a decrease in the excitation voltage to maintain the auxiliary power voltage.

8. The welding device of claim 7, wherein the auxiliary voltage is approximately 220 volts.

9. The welding device of claim 1, further comprising a switch component that is configured to receive a change in the frequency or a change in the revolutions per minute of the engine.

10. The welding device of claim 1, the generator component further comprising two poles which provides the frequency of approximately 60 Hz at the revolutions per minute of approximately 3600.

11. The welding device of claim 1, the generator component further comprising four poles which provides the frequency of approximately 60 Hz at the revolutions per minute of approximately 1800.

12. The welding device of claim 1, the generator component further comprising four poles which provides the frequency of approximately 50 Hz at the revolutions per minute of approximately 1500.

13. The welding device of claim 1, the generator component further comprising two poles which provides the frequency of approximately 50 Hz at the revolutions per minute of approximately 3000.

14. The welding device of claim 1, the field controller component includes a rheostat and a rectifier.

15. A welding device, comprising:
an engine-driven welder assembly including an engine that is configured to rotate a shaft;
a generator component having a rotor coupled to the shaft and a stator that houses the rotor, wherein the shaft rotates the rotor via the engine;
a battery that provides an initial excitation of the rotor;
the stator generates an output based on a stator winding, an engine speed, and a rotation of the stator and rotor, wherein the output includes an auxiliary output, a welding output, or an excitation output;
a controller that receives an instruction to change an engine speed or a frequency of the output, wherein the change in the engine speed or the frequency causes an increase or a decrease in the output;
a field controller component that is configured to:
receive the excitation output;
adjust the excitation output;
feed the adjusted excitation output to the rotor; and
the stator generates the auxiliary output in response to the rotor receiving the adjusted excitation voltage and the change in the engine speed or the frequency.

16. The welding device of claim 15, the field controller component includes a rheostat.

17. The welding device of claim 16, the rheostat is configured to provide an increase or a decrease in voltage to the excitation output as the adjusted excitation output.

18. The welding device of claim 16, the field controller component includes a rectifier.

19. The welding device of claim 16, field controller component includes a relay to provide an increase in voltage to the excitation output as the adjusted excitation output.

20. A method for an engine-driven welding device, comprising:
exciting a rotor with an initial excitation voltage from a power source;
generating an auxiliary power voltage at a target value, a welding voltage, and an excitation voltage with a rotational movement between the rotor and a stator;
changing a frequency setting or an engine speed;
adjusting the excitation voltage to account for the change in the frequency setting or the engine speed; and
receiving the adjusted excited voltage at the rotor which induces the stator to generate the target auxiliary power voltage at the frequency setting or with the engine speed.
